(19) United States
(12) Patent Application Publication
(10) Pub. No.: US 2015/0029202 A1
(43) Pub. Date: Jan. 29, 2015

(54) DISPLAY APPARATUS AND METHOD FOR INSPECTING THE SAME

(71) Applicant: NLT Technologies, Ltd., Kanagawa (JP)

(72) Inventor: Hirokuni YANAGIDA, Kanagawa (JP)

(73) Assignee: NLT Technologies, Ltd., Kanagawa (JP)

(21) Appl. No.: 14/165,671

(22) Filed: Jan. 28, 2014

(30) Foreign Application Priority Data
Feb. 8, 2013 (JP) 2013-023737

(51) Int. Cl. G06T 1/60

(52) U.S. Cl. CPC G06T 1/60
USPC 345/530

(57) ABSTRACT

The disclosed display apparatus eliminates the need of a dedicated inspection jig when inspecting a memory carried on the driving substrate of the display apparatus; a memory inspection can be conducted under conditions for practical use in which TCON reading memory data is operated; and another display inspection (such as a point defect inspection) can be conducted simultaneously with the memory inspection. The display apparatus includes a drive circuit for holding and utilizing operation setting data in the memory, wherein the drive circuit includes: a display data generation section which associates two values of data bits read from the memory with two values of light and shade or different colors and makes image data represented in a line or a rectangle; a switch for selecting the data generated by the display data generation section and input image data; and a switching timing control section which controls timing of switching.

### BACKGROUND OF THE INVENTION

1. Field of the Invention

The present invention relates to display apparatuses and methods for inspecting display apparatuses and particularly relates to a display apparatus and a method for inspecting a display apparatus, capable of inspecting a memory on the display apparatus without a dedicated inspection jig (such as a ROM reader) by the single display apparatus.

2. Description of the Related Art

There is an instance in which a nonvolatile memory (hereinafter abbreviated as “memory”) represented by a ROM or an EEPROM is used as means for recording data for setting the operation of a timing controller (TCON) carried on the driving substrate of a display apparatus, the production history of the display apparatus, or the like. In addition, inspection of a single driving substrate or inspection of the normality of data stored in the memory as one of processes for inspecting the display apparatus is needed for the memory on the display apparatus.

The inspection is usually performed by preparing such a dedicated inspection jig (ROM reader) as described below, separately from the display apparatus, connecting the inspection jig to a connector, a test pad, or the like disposed on the driving substrate to read data, and conducting a check (verification) of the data with expected values prepared beforehand.

The related art of Japanese Patent Laid-Open No. 2003-5733 (Patent Literature 1) is to convert data such as the production information of a display, stored in a memory section 160 illustrated in FIG. 31, into such a one-dimensional bar code as illustrated in FIG. 32 and to display the one-dimensional bar code.

In addition, an operator can read a bar code image displayed on a screen by a separately prepared bar code reader to acquire the data such as the production information of the display, stored in the memory section. A procedure before displaying the one-dimensional bar code is explained in FIG. 31 below.

First, an operator operates a bar code display selection key 113. This operation triggers a CPU included in a control section 150 to read-access the memory section 160 and to read the data such as the production information of the display, stored in the memory section 160.

Then, the data read by the CPU included in the control section 150 is sent to an OSD generation section 161. The data received by the OSD generation section 161 is converted into the image data of the one-dimensional bar code.

In addition, the one-dimensional bar code image data formed in the OSD generation section 161 is sent to a scaler 157 and is displayed on a display section 103 via a display driving section 159.

Further, the related art of Japanese Patent Laid-Open No. 2000-155560 (Patent Literature 2) is to display unique information (more specifically, self-address information D2 indicating the installation coordinate of image display sections and firmware version information D3) stored in a nonvolatile memory 225 illustrated in FIG. 33 as character information as illustrated in FIG. 34 in an image display system composed of the plural image display sections arranged in matrix form of (m+1)×(n+1).

As a result, an operator can inspect the quality of set information by visually confirming the displayed character information. A procedure before displaying the unique information (self-address information D2 and firmware version information D3) is explained in FIG. 33.

First, a switch control signal SC which indicates a unique information confirmation mode is given from a host computer installed outside the image display section to all the image display sections or a rotary switch 227 on each image display section is switched into the state of indicating the unique information confirmation mode.

The operation triggers a display apparatus control microcomputer 226 to switch a switch 222 to a b side. Simultaneously, the self-address information D2 and firmware version information D3 stored in the nonvolatile memory 225 are read under the control of the display apparatus control microcomputer 226.

The read self-address information D2 and firmware version information D3 are converted into image data by an information imaging control section 221 and applied to the b input of the switch 222.

In addition, the image data of the self-address information D2 and firmware version information D3 applied to the b input of the switch 222 is displayed on a light emitting device 211 via a drawing memory 223 and a driver 224.

In any of the related arts, memory inspection can be conducted by geometricizing data written in a memory as a one-dimensional bar code or characters to be visualized and displayed. However, these related arts have problems described below.

### CITATION LIST

### Patent Literature

[Patent Literature 1] Japanese Patent Laid-Open No. 2003-5733

[Patent Literature 2] Japanese Patent Laid-Open No. 2000-155560

In the case of the related art of Japanese Patent Laid-Open No. 2003-5733 (Patent Literature 1), a reading operation using the dedicated jig (bar code reader) is needed for conducting the check (verification) of the data written in the memory with the expected values and efforts for the inspection and to separately prepare the inspection jig are taken in order to perform the data inspection of the memory carried on the driving substrate of the display apparatus.

Further, a problem common to any of the related arts is that, since an external circuit such as an OSD generation section (information imaging control section) or a CPU (microcomputer) is needed for visualizing memory data, it is difficult to incorporate an equivalent circuit into a small display apparatus. Although the normality inspection of data written in a memory can be conducted, display utilizing the whole region and all the pixels of the display apparatus is not performed and it is therefore necessary to separately conduct the normality inspection of the display apparatus in itself (such as inspection of the presence or absence of a dead pixel or a line defect), so that inspection on conditions for practical use cannot be conducted.

Thus, the present invention is intended to solve the problems of the related arts by means described below.

### SUMMARY OF THE INVENTION

In order to solve the problems, the display apparatus of the present invention is a display apparatus including a drive circuit for holding and utilizing operation setting data in a memory, wherein the drive circuit includes: a display data generation section which associates two values of data bits read from the memory with two values of light and shade or different colors and makes image data represented in a line or a rectangle; a switch for selecting the data generated by the display data generation section and input image data; and a switching timing control section which controls timing of switching.

The switching timing control section controls switching timing to acquire display data in which the image data from the display data generation section and the input image data are arranged in one screen at an arbitrary display ratio.

The switching timing control section may also control the switching timing to switch the image data from the display data generation section and the input image data in an arbitrary frame cycle.

On the other hand, the display apparatus of the present invention is a display apparatus including a drive circuit for holding and utilizing operation setting data in a memory, wherein the drive circuit includes: a display data generation section which associates two values of data bits read from the memory with two values of light and shade or different colors and makes image data represented in a line or a rectangle: a display data comparing section which compares the data generated by the display data generation section with input image data to output image data indicating a result thereof; and a switch for selecting the data generated by the display data comparing section and an input image data.

The output image data from the display data comparing section is monochrome solid image data that is uniquely associated with a match or mismatch between comparison results.

The output image data from the display data comparing section may also be monochrome image data that is uniquely associated with a match or mismatch between comparison results and is separately painted into a match site and a mismatch site.

The output image data from the display data comparing section may also be image data matching arbitrary display inspection image data.

On the other hand, a method for inspecting a display apparatus according to the present invention includes arranging and displaying input display data and data obtained by imaging operation setting data; and inspecting matching thereof.

Further, a method for inspecting a display apparatus according to the present invention includes alternately displaying input display data and data obtained by imaging operation setting data in an arbitrary frame cycle; and inspecting the presence or absence of a flicker.

Furthermore, a method for inspecting a display apparatus according to the present invention may also include displaying a comparison result screen for input display data and data obtained by imaging operation setting data; and confirming whether the screen is an acceptance screen or not.

On the other hand, a method for inspecting a display apparatus according to the present invention may also include using a comparison result screen display for input display data and data obtained by imaging operation setting data, doubling as another display inspection screen.

In the display apparatus according to the present invention, the need of a dedicated inspection jig for inspecting a memory is eliminated by imaging (visualizing) memory data in the single display apparatus.

In particular, in the display apparatus according to the present invention, the number of circuits disposed for inspection, such as an OSD generation section, can be reduced in comparison with the related art such as Japanese Patent Laid-Open No. 2003-5733 (Patent Literature 1) or Japanese Patent Laid-Open No. 2000-15560 (Patent Literature 2) by positively utilizing the functions of TCON and horizontal drivers. Thus, there is also the effect of reducing the number of components.

Furthermore, the visualized image of memory data and an expected value image from an external input are displayed or the visualized image of the memory data, the expected value image, and an inspection screen are displayed in the same screen or video (in successive images) in the display apparatus according to the present invention. Further, there is made such a configuration that an expected value check (verification) between the visualized image of the memory data and the expected value image from the external input is performed to output an acceptance/rejection screen and to use an acceptance screen doubling as another inspection screen.

As a result, a memory inspection can be conducted under conditions for practical use in which TCON reading the memory data is operated and inspection time can be shortened by conducting the memory inspection simultaneously with another display inspection (such as a point defect inspection).

### BRIEF DESCRIPTION OF THE DRAWINGS

FIG. 1 is a view that illustrates the configuration of a display apparatus in Embodiment 1 of the present invention;

FIG. 2 is an internal functional block diagram of TCON incorporated into the display apparatus in Embodiment 1 of the present invention;

FIG. 3 is a view that illustrates an example of an image generated by a display data generation section 14 in Embodiment 1 of the present invention;

FIG. 4 is a view that illustrates a display example in the case of just displaying image data on an input image signal line 31 in Embodiment 1 of the present invention;

FIG. 5 is a view that illustrates an image display example in a case in which m-bit memory data matches an expected value thereof in Embodiment 1 of the present invention;

FIG. 6 is a view that illustrates an image display example in a case in which m-bit memory data does not match an expected value thereof in Embodiment 1 of the present invention;

FIG. 7 is a view that illustrates an image display example in the case of increasing the range of inspecting memory data to 2m bits in Embodiment 1 of the present invention;

FIG. 8 is a view that illustrates an image display example in the case of displaying a gray scale inspection screen simultaneously with the inspection of memory data in Embodiment 1 of the present invention;

FIG. 9 is an internal functional block diagram of TCON incorporated into a display apparatus in Embodiment 2 of the present invention;

FIG. 10 is a time chart that indicates the operation of a switching timing control section 16 in Embodiment 2 of the present invention;

FIG. 11 is a view that illustrates one example of the circuit of the switching timing control section 16 in Embodiment 2 of the present invention;

FIG. 12 is a view that illustrates an image display example in a case in which memory data matches an expected value thereof in Embodiment 2 of the present invention;

FIG. 13 is a view that illustrates image display in a case in which memory data does not match an expected value thereof in Embodiment 2 of the present invention;

FIG. 14 is an internal functional block diagram of TCON incorporated into a display apparatus in Embodiment 3 of the present invention;

FIG. 15 is a view that illustrates an operation example of a display data comparing section in Embodiment 3 of the present invention in a case in which memory data matches an expected value thereof (inspection acceptance);

FIG. 16 is a view that illustrates an operation example of the display data comparing section in Embodiment 3 of the present invention, in which inspection NG is output using a full screen in a case in which memory data does not match an expected value thereof;

FIG. 17 is a view that illustrates an operation example of the display data comparing section in Embodiment 3 of the present invention, in which a white display is output only for a data section with inspection NG in a case in which memory data does not match an expected value thereof;

FIG. 18 is an internal functional block diagram of TCON incorporated into a display apparatus in Embodiment 4 of the present invention;

FIG. 19 is a view that illustrates an image display example corresponding to an operation illustrated in FIG. 20 in Embodiment 4 of the present invention;

FIG. 20 is a time chart of a gate, a drain, and DLP in the case of displaying an image illustrated in FIG. 19;

FIG. 21 is a time chart of a gate, a drain, and DLP in the case of generating a memory visualization image in Embodiment 4 of the present invention;

FIG. 22 is a memory visualization image acquired from a driving signal illustrated in the time chart of FIG. 21;

FIG. 23 is a view that illustrates an image display example in a case in which memory data matches an expected value thereof in Embodiment 4 of the present invention;

FIG. 24 is a view that illustrates an image display example in a case in which memory data does not match an expected value thereof in Embodiment 4 of the present invention;

FIG. 25 is a view that illustrates the configuration of a display apparatus in Embodiment 5 of the present invention;

FIG. 26 is an internal functional block diagram of TCON incorporated into the display apparatus in Embodiment 5 of the present invention;

FIG. 27 is a view that illustrates an image display example in a case in which m-bit memory data matches an expected value thereof in Embodiment 5 of the present invention;

FIG. 28 is a view that illustrates an image display example in a case in which m-bit memory data does not match an expected value thereof in Embodiment 5 of the present invention;

FIG. 29 is a view that illustrates an image display example in the case of increasing the inspection range of memory data to 2m bits in Embodiment 5 of the present invention;

FIG. 30 is a view that illustrates an image display example in the case of displaying a gray scale inspection screen simultaneously with the inspection of memory data in Embodiment 1 of the present invention;

FIG. 31 is a circuit block diagram in the related art disclosed in Japanese Patent Laid-Open No. 2003-5733 (Patent Literature 1);

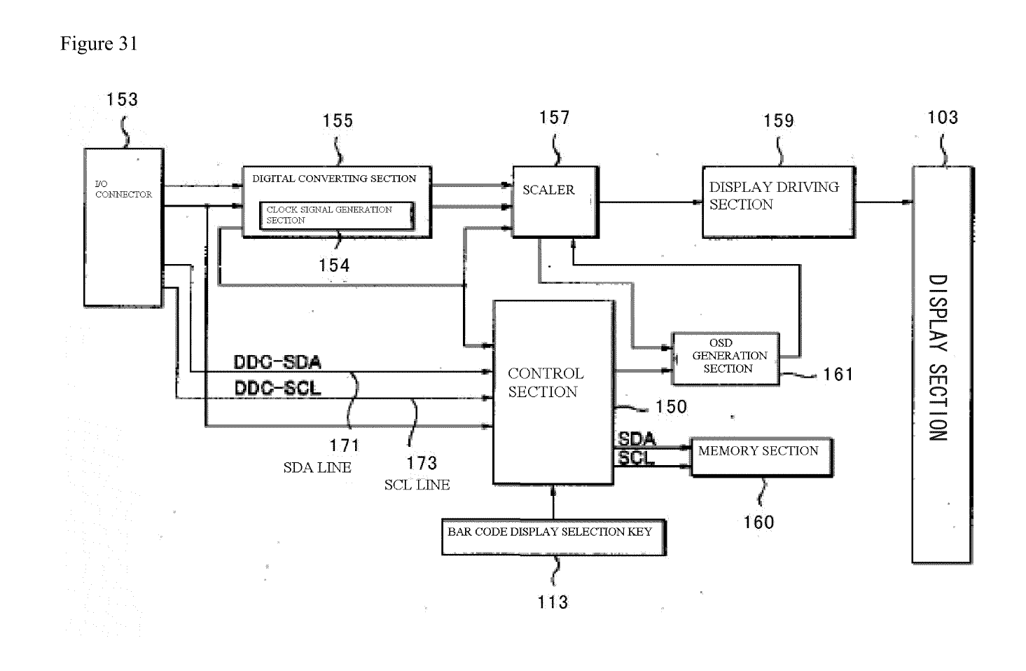

FIG. 32 is a view that illustrates a screen display example of memory data in the related art disclosed in Japanese Patent Laid-Open No. 2003-5733 (Patent Literature 1);

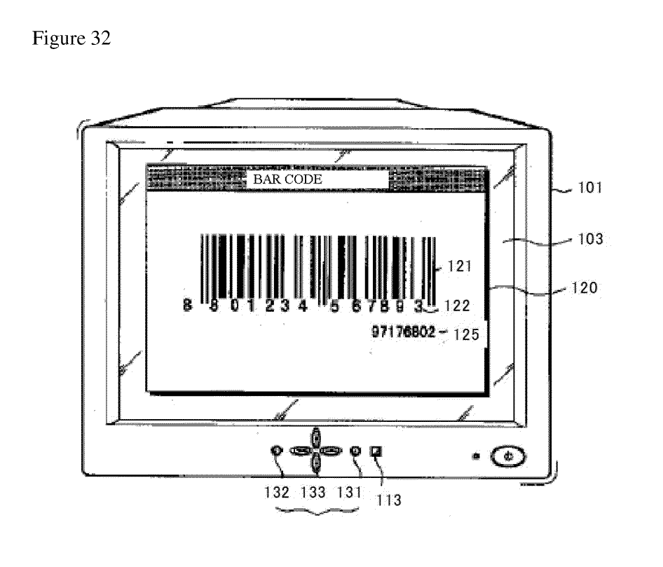

FIG. 33 is a circuit block diagram in the related art disclosed in Japanese Patent Laid-Open No. 2000-155560 (Patent Literature 2);

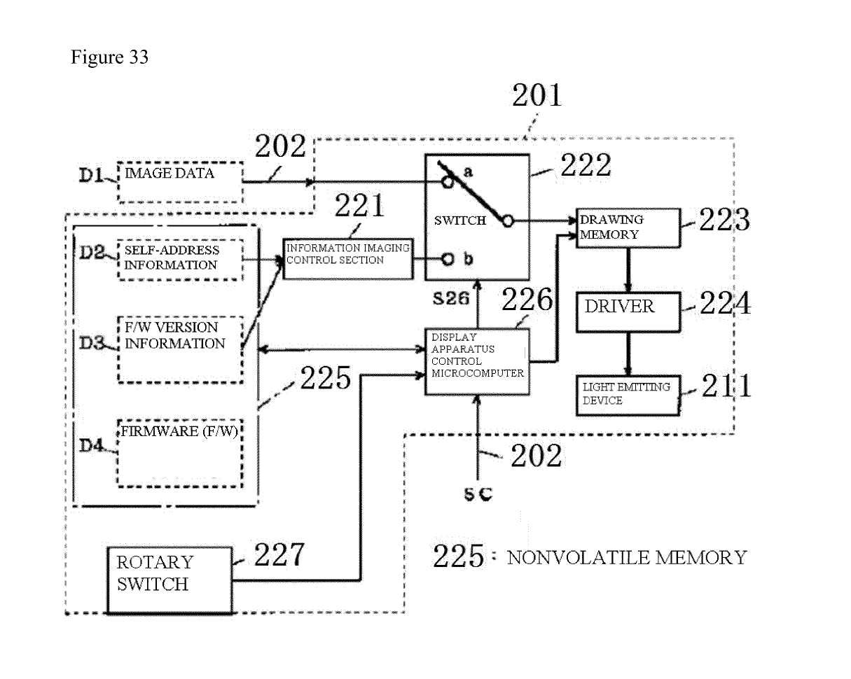

FIG. 34 is a view that illustrates a screen display example of memory data in the related art disclosed in Japanese Patent Laid-Open No. 2000-155560) (Patent Literature 2).

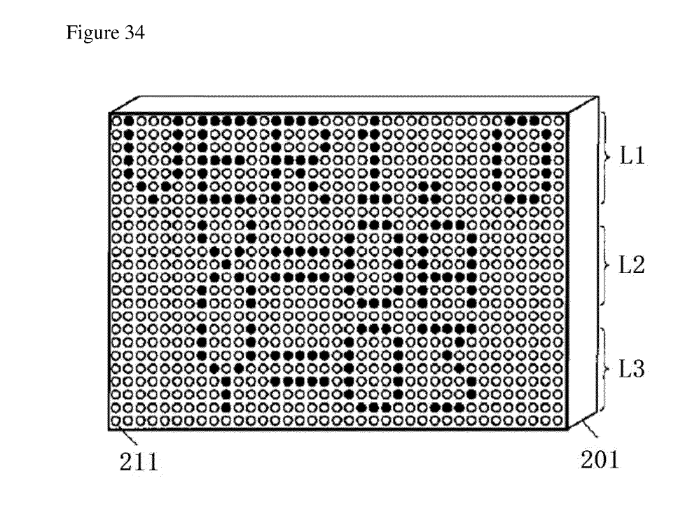

### DETAILED DESCRIPTION OF THE PREFERRED EMBODIMENTS

A display apparatus according to each of the present embodiments and a method for inspecting a display apparatus are explained below with reference to the drawings.

### Embodiment 1

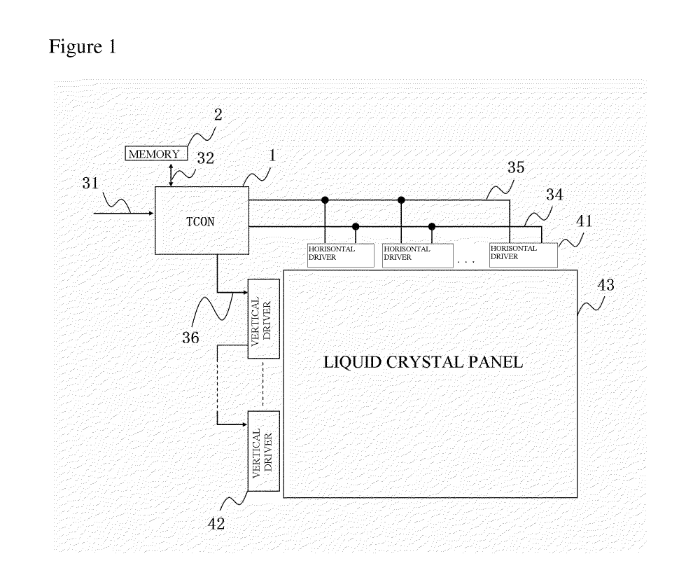

FIG. 1 is a functional block diagram of a display apparatus in Embodiment 1 of the present invention and is the same as a functional block diagram of a general display apparatus including a memory in which setting data is stored. The display apparatus includes TCON 1, a memory 2, a liquid crystal panel 43, horizontal drivers 41 for driving the liquid crystal panel 43, and vertical drivers 42.

An input image signal line 31 is connected from the outside to TCON 1. On the other hand, the memory 2 and a memory control signal line 32 are connected to TCON 1. Further, TCON 1 is connected to the horizontal drivers 41 through a horizontal driver control signal line 35 and a horizontal driver pixel data line 34 and is connected to the vertical drivers 42 through a vertical driver control signal 36. In addition, the horizontal drivers 41 and the vertical drivers 42 are each connected to the liquid crystal panel 43.

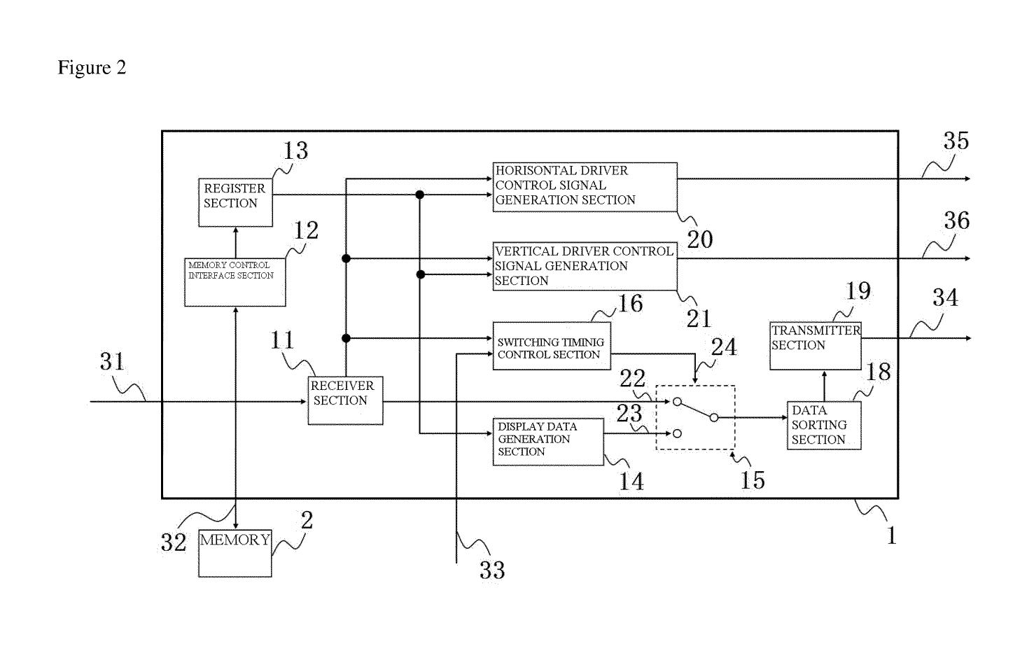

FIG. 2 is a functional block diagram of the inside of TCON 1 carried by the display apparatus according to Embodiment 1. TCON 1 includes: a receiver section 11 connected to the input image signal line 31; a switch 15 connected to the receiver portion through an internal signal line 22; a switching timing control section 16 connected to the switch 15 through a switching signal line 24 and also connected to the receiver section 11; in addition, a horizontal driver control signal generation section 20 connected to the receiver section 11; and a vertical driver control signal generation section 21.

On the other hand, a memory control interface section 12 connected to the memory 2 outside TCON 1 through the memory control signal line 32 is disposed. The memory control interface section 12 is connected to a register section 13. The register section 13 is connected to each of the horizontal driver control signal generation section 20, the vertical driver control signal generation section 21, and a display data generation section 14.

The switch 15 is connected to the receiver section 11 through the internal signal line 22 and is connected to the display data generation section 14 through an internal signal line 23. By a signal from the switching signal line 24 of the switching timing control section 16, the internal signal line 22 or the internal signal line 23 is selected and connected to a data sorting section 18. The data sorting section 18 is connected to a transmitter section 19.

The horizontal driver control signal generation section 20 outputs the horizontal driver control signal 35 to the outside of TCON 1. The vertical driver control signal generation section 21 outputs the vertical driver control signal 36 to the outside of TCON 1. The transmitter section 19 outputs the horizontal driver pixel data 34 to the outside of TCON 1.

Next, the operation of Embodiment 1 is explained with reference to FIG. 2 to FIG. 5. The register section 13 of TCON 1 illustrated in FIG. 2 is a volatile memory for holding an operation setting parameter such as screen resolution information required by generation of a control signal in the horizontal driver control signal generation section 20 or the vertical driver control signal generation section 21.

TCON 1 conducts read access to the memory 2 via the memory control signal line 32 by the autonomous control of the memory control interface section 12 at arbitrary timing after power activation. Read data is held in the register section 13 in TCON 1. The data held in the register section 13 is passed to various functional blocks in TCON 1. Then, an operation as TCON is started.

The display data generation section 14 has the function of reading data on the register section 13 (=data stored in the memory 2) and converting the read data into image data according to a predetermined algorithm.

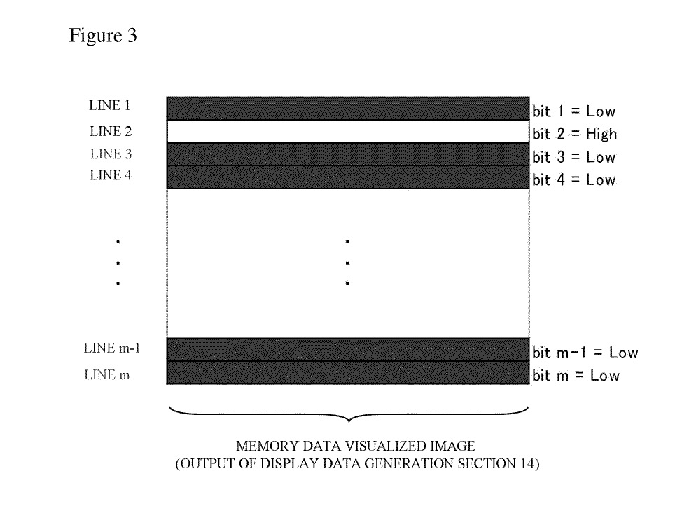

An example of image data generated in the display data generation section 14 is illustrated in FIG. 3. The example represents an image example generated by an algorithm that associates the two Low/High values of respective bits with black line/white line displays from the top of a data row on the register section 13. Generated image data can be optionally changed by changing the image data making algorithm of the display data generation section 14. The two Low/High values of the respective bits may also be associated with different two levels or colors other than black/white. Although the amount of information that can be represented is decreased, 1-bit information may also be represented by a rectangular shape gathered in plural consecutive lines.

The switch 15 illustrated in FIG. 2 has the function of selecting the internal signal 22 or the internal signal 23 by the state of the switching signal line 24 which is an output from the switching timing control section 16.

The switching timing control section 16 has the function of generating the switching signal 24 for controlling the switch 15 according to a predetermined algorithm in synchronization with a timing signal extracted from the input image signal line 31 input from the receiver section 11 and a test enable signal 33 from the outside of TCON 1.

The detailed operation of the switching timing control section 16 is explained. When the test enable signal 33 gives a direction for a normal operation mode, the switching timing control section 16 outputs a control signal for selecting the internal signal 22 to the switch 15 via the switching signal line 24. At this time, image data on the input image signal line 31 is displayed on the display apparatus.

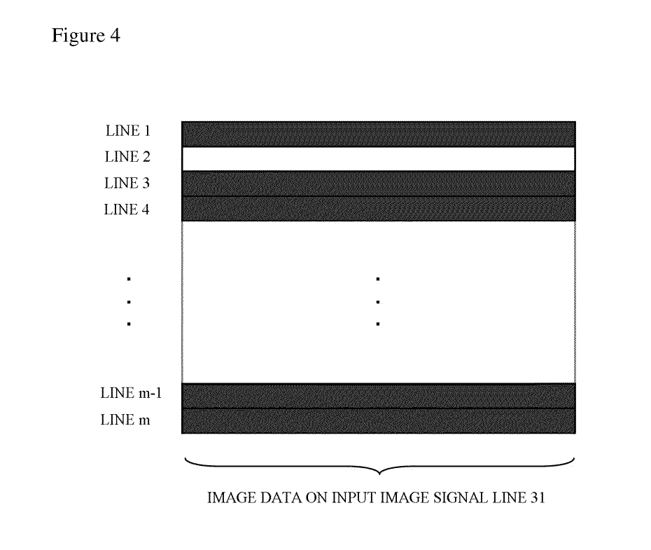

As an example, when the test enable signal 33 gives a direction for a normal operation mode, an image illustrated in FIG. 4 is just displayed on the liquid crystal panel 43 in the case of inputting the image illustrated in FIG. 4 as image data on the input image signal line 31 into TCON 1. A series of the operations is the same as the operations of common TCON.

On the other hand, when the test enable signal 33 gives a direction for a test mode, the switching timing control section 16 outputs a signal for controlling the switch 15 on the switching signal line 24 according to a timing signal extracted from the input image signal line 31 input from the receiver section 11 and a preset control algorithm.

Specifically, the switch 15 is controlled to generate image data in which both images of image data on the internal signal 22 which is an output from the receiver section 11 (=image data on the input image signal line 31) and image data on the internal signal 23 (=output image from the display data generation section 14) are subjected to region splitting and arranged in one screen.

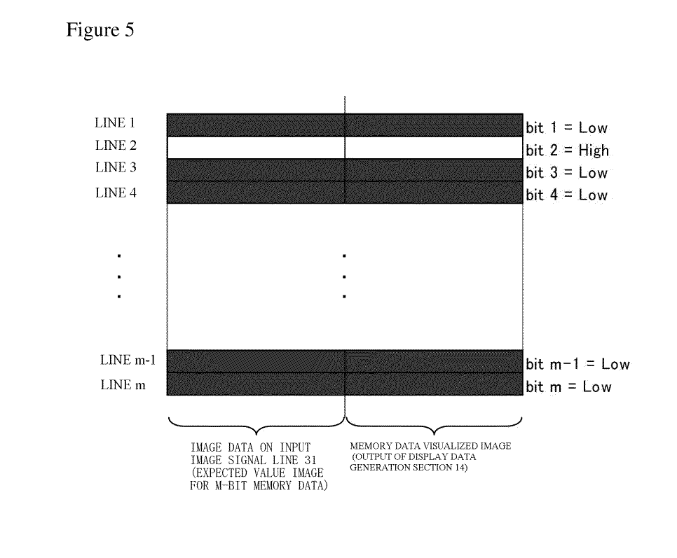

FIG. 5 illustrates an example of an image displayed on the liquid crystal panel 43 when the test enable signal 33 gives a direction for a test mode, the image illustrated in FIG. 4 is input as image data on the input image signal line 31, and image data illustrated in FIG. 3 is generated in the display data generation section 14.

In the present example, a display region is split into two regions in the center of the screen and an image generated in the display data generation section 14 and image data on the input image signal line 31 are arranged and displayed in the right and left regions, respectively. However, the arrangement of the image data on the input image signal line 31 and the image generated in the display data generation section 14, a region splitting ratio, a splitting direction, and the number of splits can be optionally changed by changing the control algorithm of the switching timing control section 16.

The specific effect of Embodiment 1 is explained. The display apparatus described in the present embodiment sets a signal for giving a direction for a normal operation mode to the test enable signal 33 during normal use. In this state, the display apparatus of the present embodiment operates similarly with a common display apparatus.

On the other hand, when the inspection of the contents of the memory 2 (check of an expected value) is conducted in, e.g., inspection in a plant, an inspector sets a signal for giving a direction for a test mode to the test enable signal 33. Simultaneously, expected value image data presumed from data stored in the memory 2 is input as image data on the input image signal line 31.

The expected value image data can be easily presumed and generated by an inspector knowing an algorithm for imaging expected value data to be stored in the memory 2 and memory data executed in the display data generation section 14 in TCON 1.

The inspector compares an expected value image displayed in one screen (=image data on input image signal line 31) with an image read and generated from the memory 2 by TCON 1 (memory data visualized image) and judges whether memory data is normal or abnormal based on the presence or absence of a difference between both images.

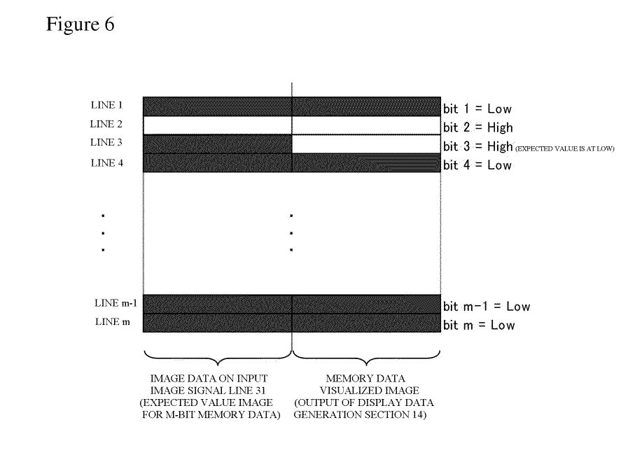

FIG. 5 illustrates an inspection screen display example in a case in which data stored in the memory 2 is normal (matches an expected value), while FIG. 6 illustrates an inspection screen display example in a case in which data stored in the memory 2 is abnormal (does not match an expected value).

Although memory check equivalent only to m bits based on the number m of longitudinal lines on the screen can be conducted in the above examples, data check of up to n×m bits per screen is possible when the number of splits on the screen is 2n (n is an integer of 1 or more).

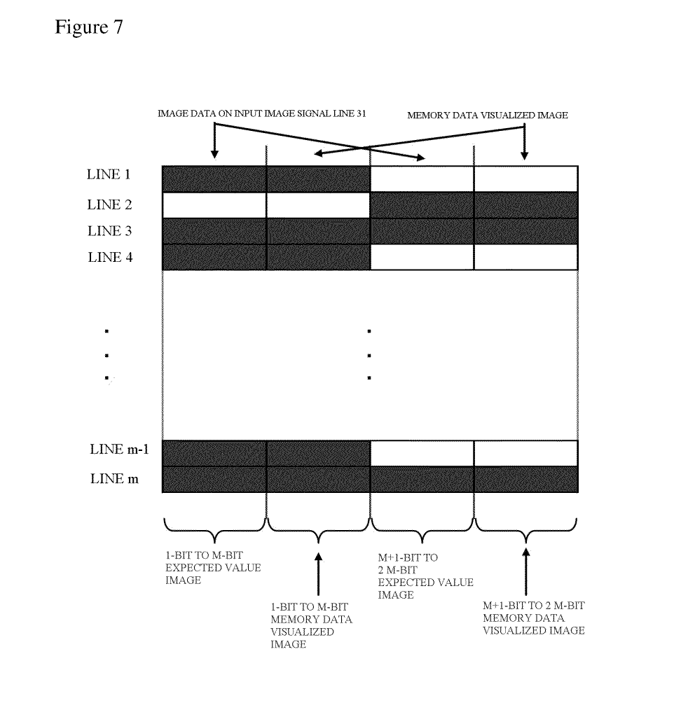

As an example, an inspection screen display example in a case in which the number of splits on a screen is four and 2m-bit data check is conducted is illustrated in FIG. 7. The number of splits on the screen, a splitting direction, and a display content can be optionally changed by changing the control algorithm of the switching timing control section 16.

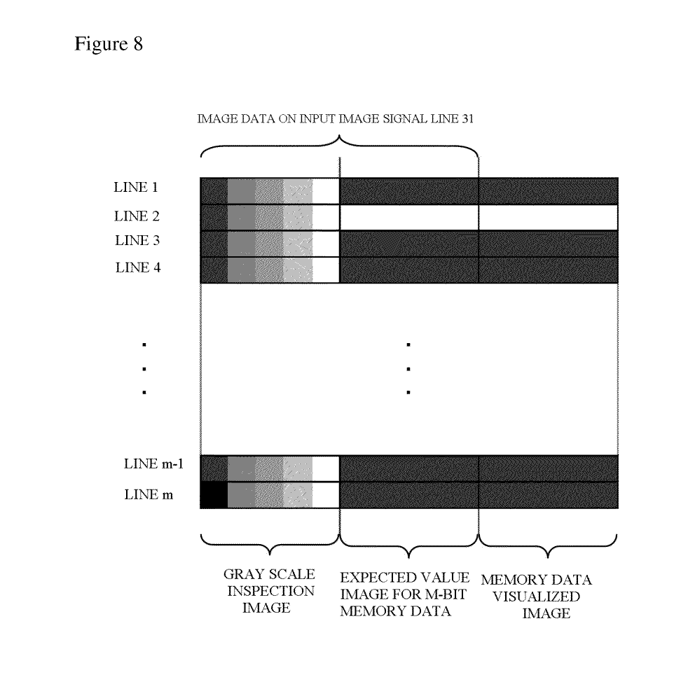

Furthermore, arbitrary display inspection can also be conducted simultaneously with the inspection of the content of memory data by inputting, as image data on the input image signal line 31, image data obtained by synthesizing the expected value image data of memory data and arbitrary image data for display inspection. As an example, an inspection screen display example in which the expected value image of memory data and a gray scale display inspection image are simultaneously input to simultaneously conduct the inspection of the content of the memory data and gray scale display inspection is illustrated in FIG. 8.

In accordance with the present embodiment, a memory data visualized image is exemplified as image data represented by two colors of white/black. However, a similar effect is obtained even in the case of image data represented by different two levels or colors other than white/black.

Since a series of the operations can be executed in a single display apparatus, the need of a dedicated inspection jig such as a ROM reader is eliminated and the attachment and detachment operation of the inspection jig for a module is also avoided. Therefore, inspection operation time can be shortened.

Since the inspection of the memory 2 is conducted while observing a display image as mentioned above, the inspection can be conducted while being incorporated into a part of a display inspection process and, in addition, the inspection of the memory 2 and arbitrary display inspection can be simultaneously conducted on the same screen, so that inspection time can be shortened.

On the other hand, in the inspection using the inspection jig, although it can be inspected whether data written in a memory is intended by an inspector or not, inspection whether the data normally functions in the state in which the data is actually read by TCON 1 and operated for a display apparatus (actual operation state) cannot be conducted. In view of this, the inspection in the actual operation state in which memory data is actually read in TCON 1 and is operated for the display apparatus is possible in the present embodiment

### Embodiment 2

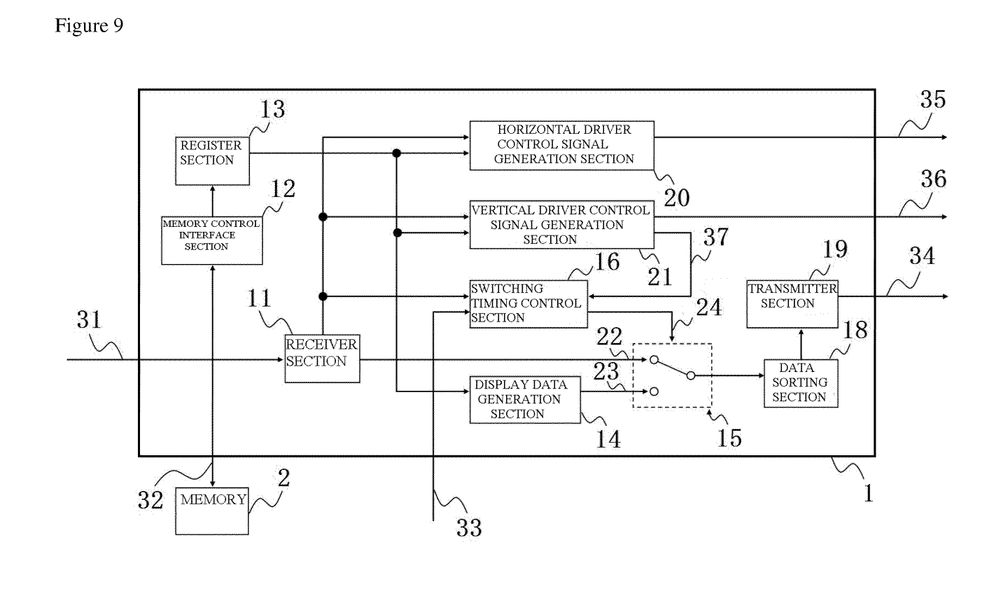

FIG. 9 illustrates a functional block diagram of the inside of TCON 1 carried by a display apparatus in Embodiment 2 of the present invention. The functional block diagram of the display apparatus according to Embodiment 2 is the same as the functional block diagram of the display apparatus in Embodiment 1.

The differences between Embodiment 1 and Embodiment 2 are: the addition of a signal line 37 for leading a vertical driver start pulse from the vertical driver control signal generation section 21 to the switching timing control section 16 in TCON 1; and the change of the switching control algorithm in the switching timing control section 16.

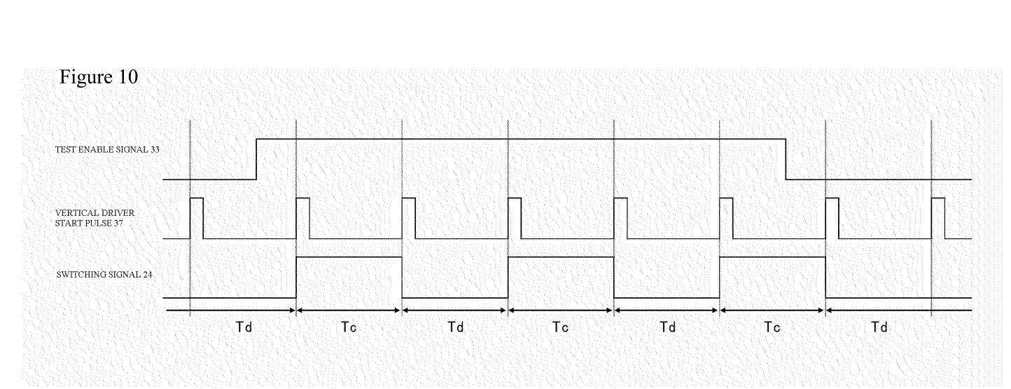

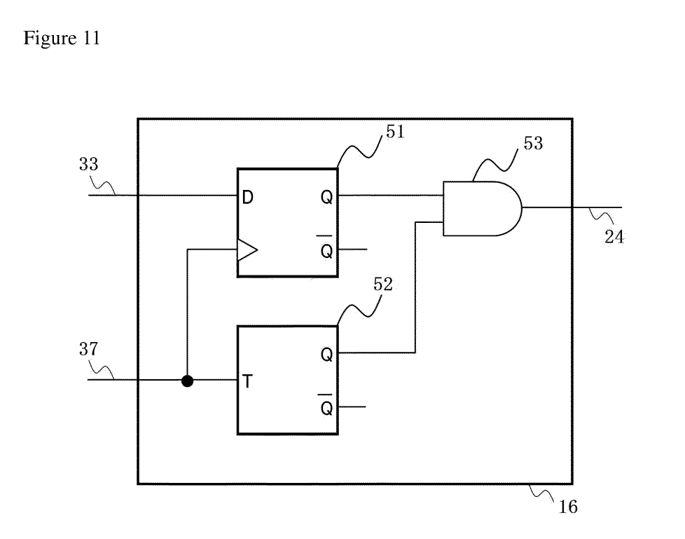

Next, an example of the operation of the switching timing control section 16, which is a difference between Embodiment 1 and Embodiment 2, is explained with reference to the time chart of FIG. 10. In the time chart of FIG. 10, High and Low of the test enable signal 33 correspond to a test mode direction state and a normal operation mode direction state, respectively. Further, High and Low of the switching signal 24 correspond to the internal signal 23 side selection direction state and internal signal 22 side selection direction state of the switch 15, respectively. In addition. FIG. 11 illustrates an example of a circuit that realizes the operation of the time chart illustrated in FIG. 10.

The alternate switching of the output state of a switching signal 24, which is the output of a switching timing control section 16, to High/Low is triggered by the input of a vertical driver start pulse 37 in a period in which a test enable signal 33 is at High. The High/Low switching cycle of the switching signal 24 conforms to the input cycle of the vertical driver start pulse 37, i.e., a one-frame display cycle.

The switching signal 24 is fixed at Low in a period in which the test enable signal 33 is at Low with or without the input of the vertical driver start pulse 37. However, when the test enable signal 33 is switched from High to Low during a period in which the switching signal 24 is at a High output, the switching signal 24 is lowered from High to Low at the time of the subsequent input of the vertical driver start pulse 37.

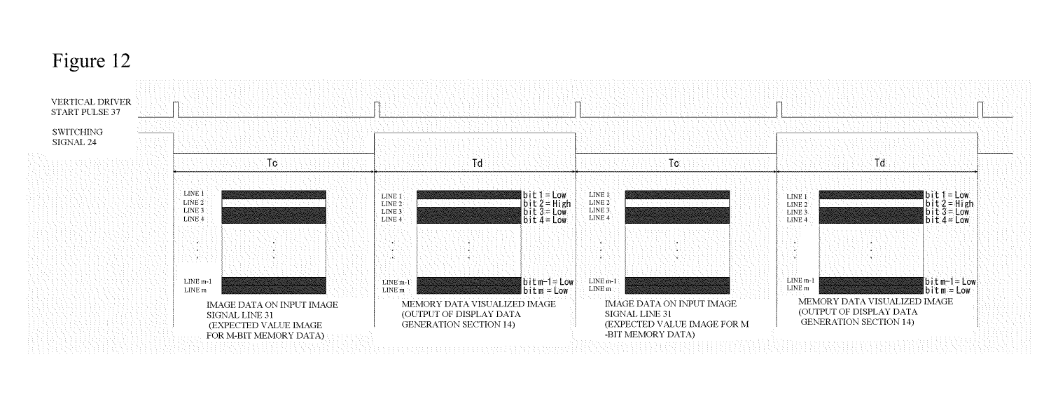

FIG. 12 illustrates the relationship of the vertical driver start pulse 37, the switching signal 24, and a display on the display apparatus in a case in which the test enable signal 33 is fixed at High.

As mentioned above, High/Low of the output of the switching signal 24 is switched every time the vertical driver start pulse 37 is input in a period in which the test enable signal 33 is at High.

Since the switch 15 in TCON 1 performs the operations of selecting an internal signal 22 in a period in which the switching signal 24 is at Low (period Tc) and of selecting an internal signal 23 in a period in which the switching signal 24 is at High (period Td), image data on an input image signal line 31 and an image, in which data stored in the memory 2 is visualized, generated in a display data generation section 14 are displayed on a liquid crystal panel 43 in the period Tc and the period Td, respectively, and a switching cycle thereof conforms to a one-frame display cycle.

In the above operations, the example of switching a display image in a one-frame cycle is described. However, in accordance with the present invention, the algorithm of the switching timing control section 16 may also be made to switch a display screen in an n-frame cycle (n is an integer of 1 or more).

The specific effect of Embodiment 2 is explained. The display apparatus described in the present embodiment sets a signal for giving a direction for a normal operation mode to the test enable signal 33 during normal use. In this state, the display apparatus of the present embodiment operates similarly with a common display apparatus.

On the other hand, when the inspection of the contents of the memory 2 (check of an expected value) is conducted in, e.g., inspection in a plant, an inspector sets a signal for giving a direction for a test mode to the test enable signal 33. Simultaneously, expected value image data presumed from data stored in the memory 2 is input as image data on the input image signal line 31.

The expected value image data can be easily presumed and generated by an inspector knowing an algorithm for imaging expected value data to be stored in the memory 2 and memory data executed in the display data generation section 14 in TCON 1.

The inspector alternately observes an expected value image (image data on the input image signal line 31) and a memory data visualized image in an n-frame display cycle (n is an integer of 1 or more). In this case, when there is no difference between the expected value image and the memory data visualized image, i.e., the data stored in the memory 2 matches the expected value (normal), images displayed in all frames are the same and no flicker is recognized by the inspector.

In contrast, when there is a difference between the expected value image and the memory data visualized image, i.e., the data stored in the memory 2 mismatches the expected value (abnormal), a portion in which the difference is produced is recognized as a flicker by the inspector.

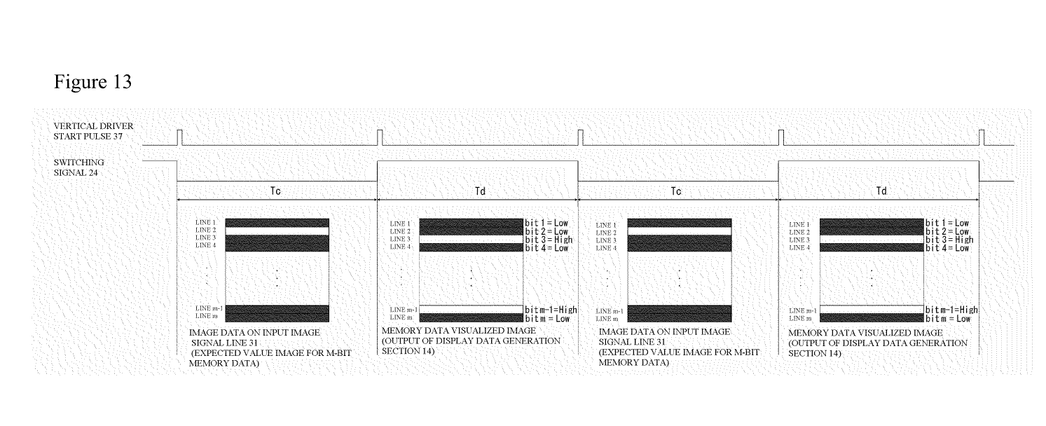

FIG. 12 illustrates a display example in a case in which read memory data matches an expected value, while FIG. 13 illustrates a display example in a case in which read memory data does not match an expected value.

In FIG. 12, there is no difference between an expected value image generated from the memory data expected value and input into the display apparatus and a memory data visualized image generated by actually reading the memory by TCON 1 and no flicker is therefore recognized by the inspector.

On the other hand, in FIG. 13, there is a difference between an expected value image and a memory data visualized image in a display at m−1 bits, i.e., there is a state in which the expected value at m−1 bits does not match the data at m−1 bits read from the memory 2, so that this display region is recognized as a flicker by the inspector.

The inspector can judge whether data stored in the memory 2 is normal or abnormal by confirming the presence or absence of a flicker produced on a screen. A data spot where abnormality occurs can also be known by specifying a spot where the flicker is produced.

Furthermore, as in the case of Embodiment 1, arbitrary display inspection can also be conducted simultaneously with the inspection of the content of memory data by inputting, as image data on the input image signal line 31, an image obtained by synthesizing the expected value image of memory data and an arbitrary image for display inspection.

In accordance with the present embodiment, a memory data visualized image is exemplified as image data represented by two colors of white/black. However, a similar effect is obtained even in the case of image data represented by different two levels or colors other than white/black.

Since a series of the operations can be executed in a single display apparatus, the need of a dedicated inspection jig such as a ROM reader is eliminated and the attachment and detachment operation of the inspection jig for a module is also avoided. Therefore, inspection operation time can be shortened.

Since the inspection of the memory 2 is conducted while observing a display image as mentioned above, the inspection can be conducted while being incorporated into a part of a display inspection process and, in addition, the inspection of the memory 2 and arbitrary display inspection can also be simultaneously conducted on the same screen, so that inspection time can be shortened.

In addition, as in the case of Embodiment 1, there is also the effect of enabling the inspection in the actual operation state in which memory data is actually read in TCON 1 and is operated for the display apparatus.

### Embodiment 3

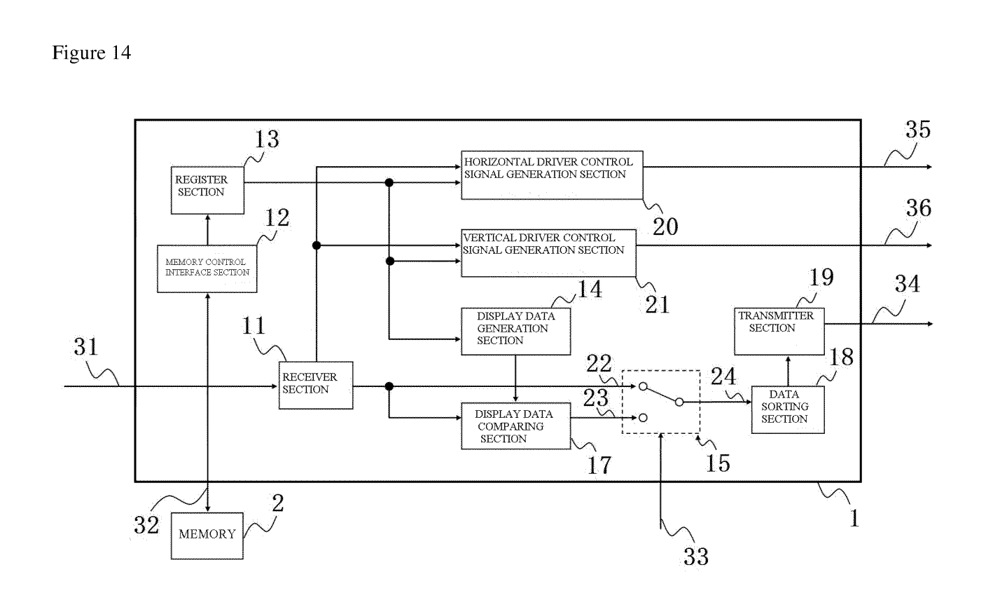

FIG. 14 illustrates a functional block diagram of the inside of TCON 1 carried by a display apparatus in Embodiment 3 of the present invention. The functional block diagram of the display apparatus according to Embodiment 3 is the same as the functional block diagram of the display apparatus in Embodiment 1.

The differences between Embodiment 1 and Embodiment 3 are in that the test enable signal 33 from the outside is connected to the switch 15 in the absence of the switching timing control section 16, in that the output of the receiver section 11 is connected to the switch 15 via the internal signal 22 and also connected to a display data comparing section 17 which is newly disposed, and in that a point to which the output of the display data generation section 14 is connected is changed from the switch 15 to the display data comparing section 17.

The operation of Embodiment 3 is explained below. A signal from a register section 13 is input into the display data generation section 14 to output memory visualized image data generated according to a predetermined algorithm to the display data comparing section 17. The operation is the same as that of Embodiment 1.

The output signal of the receiver section 11 and the output signal of the display data comparing section 17 are connected to the input side of the switch 15. The switching of the switch 15 is controlled by the test enable signal 33. Specifically, the switch 15 conducts the operation of selecting the internal signal line 22 when the test enable signal 33 gives a direction for a normal operation mode and the switch 15 conducts the operation of selecting the internal signal line 23 when the test enable signal 33 gives a direction for a test mode.

The display data comparing section 17 compares the output image data of the receiver section 11 (=image data on the input image signal line 31) with the output image data of the display data generation section 14 (=visualized image of data stored in the memory 2) in a bit unit and outputs the result as image data to the switch 15 in a subsequent stage via the internal signal line 23.

The display data comparing section 17 may compares the output image data of the receiver section 11 with the output image data of the display data generation section 14 in any system of determining the logical product (AND) of the comparison result (match/mismatch) of image data at each of all the bits to output the result or of gathering the comparison result in an n-bit unit and determining a logical product in the gathered bit unit to output the result. However, n is an integer of 1 or more.

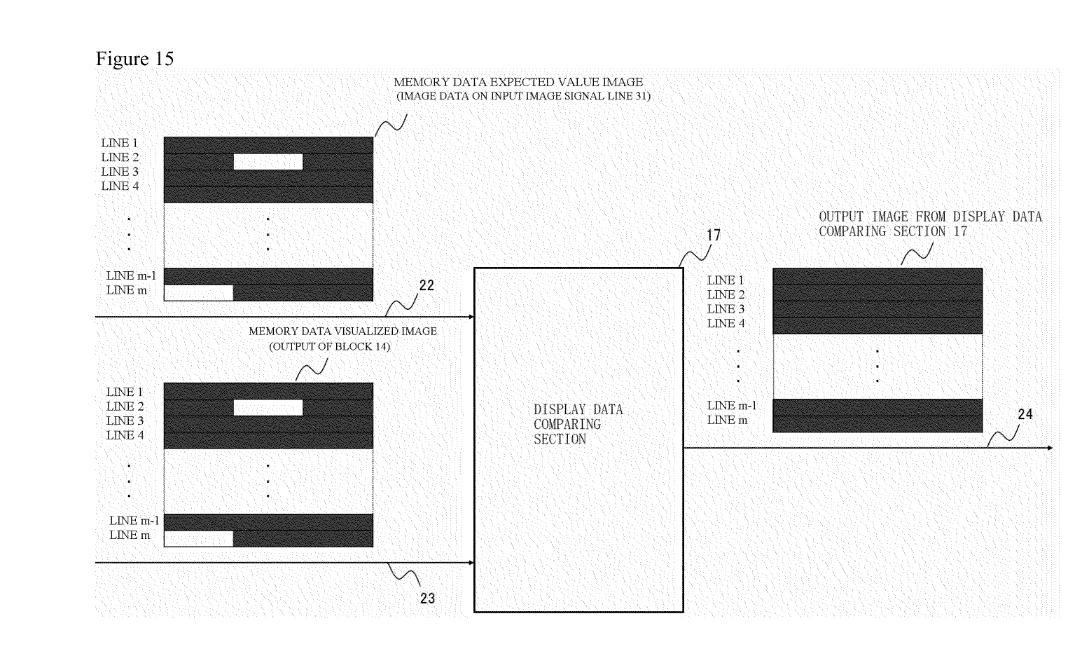

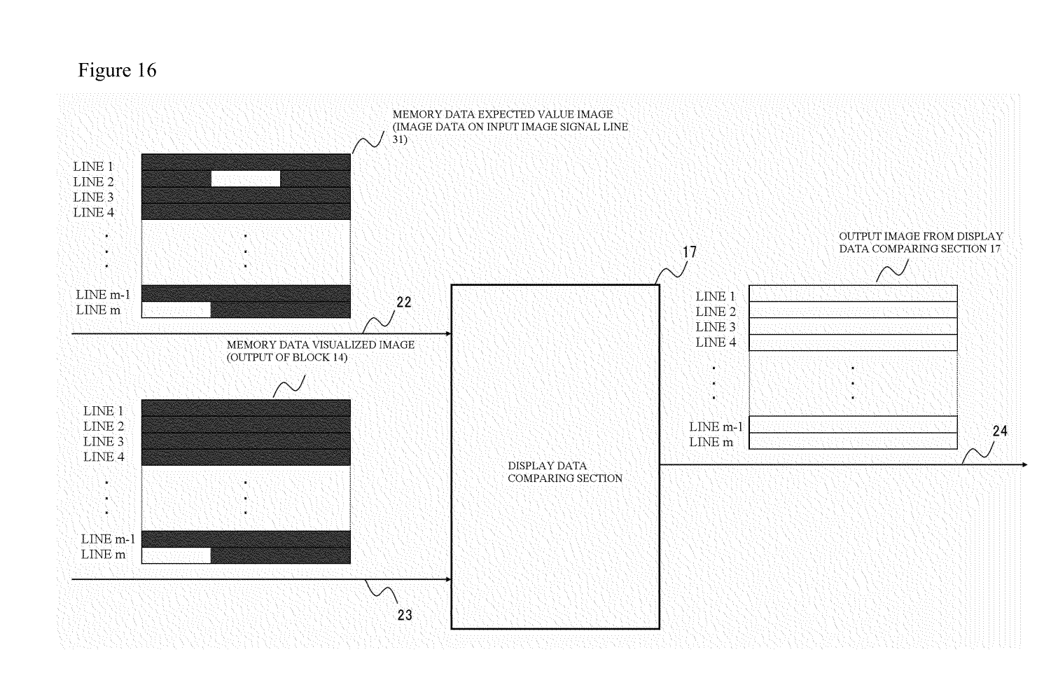

As an example, the relationship between the input image data and output image data of the display data comparing section 17 in a case in which the display data comparing section 17 is in the system of determining the logical product of the comparison result at each of all the bits to output the logical product is explained with reference to FIG. 15 and FIG. 16.

In this example, “match” and “mismatch” as comparison results are associated with black and white displays, respectively. When the output image data of the receiver section 11 (=image data on the input image signal line 31) which is the input of the display data comparing section 17 completely matches the output image data of the display data generation section 14 (=visualized image of data stored in the memory 2), the output image data of the display data comparing section 17 is image data in which all the pixels are black as illustrated in FIG. 15.

On the other hand, when there is a difference between the output image data of the receiver section 11 and the output image data of the display data generation section 14 by 1 or more bits, the output image data of the display data comparing section 17 is image data in which all the pixels are white as illustrated in FIG. 16.

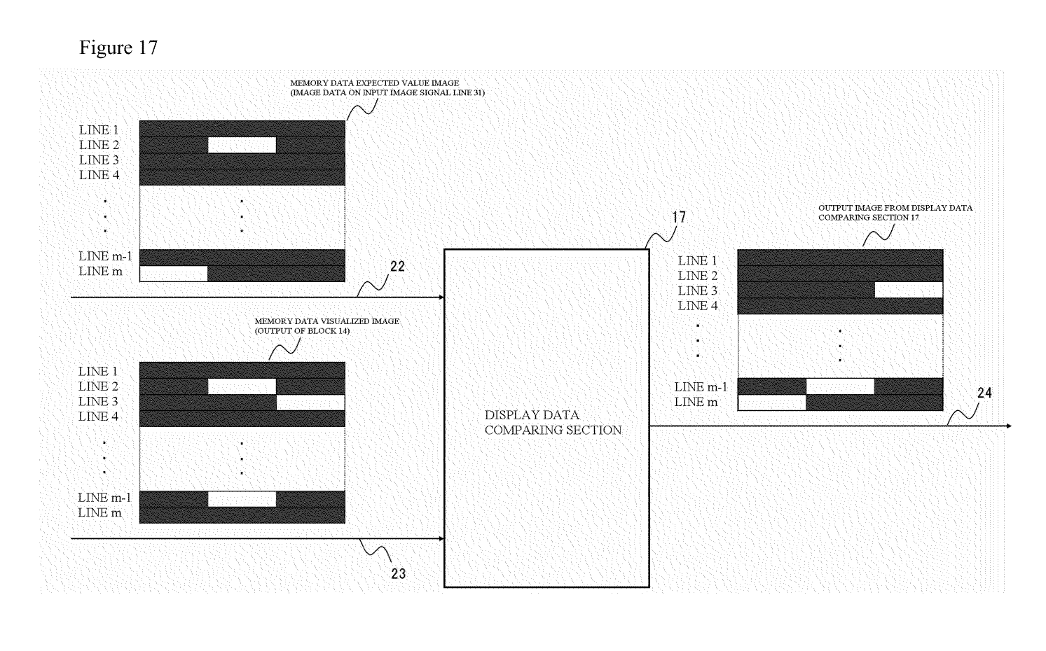

Further, as another example, the relationship between the input image data and output image data of the display data comparing section 17 in a case in which the display data comparing section 17 is in the system of gathering the comparison results in the n-bit unit, determining the logical product in the unit of the number of gathered bits, and outputting the result is explained with reference to FIG. 15 and FIG. 17. The example in the case of n=1 is described.

In this example, “match” and “mismatch” as comparison results are associated with black and white displays, respectively. When the output image data of the receiver section 11 which is the input of the display data comparing section 17 completely matches the output image data of the display data generation section 14, the output image data of the display data comparing section 17 is image data in which all the pixels are black as illustrated in FIG. 15. This is the same as the above example.

In contrast, when there is a difference between the output image data of the receiver section 11 and the output image data of the display data generation section 14, the output image data of the display data comparing section 17 is image data in which a pixel in a spot without a difference is black while a pixel in a spot with a differences is white as illustrated in FIG. 17. In these examples, the match and mismatch of the comparison results are associated with two colors of black and white but may also be associated with different two levels and colors other than black/white. The comparison results gathered in an n-bit unit in the case of n>1 (n is an integer) may also be displayed.

The specific effect of Embodiment 3 is explained. The display apparatus described in the present embodiment sets a signal for giving a direction for a normal operation mode to the test enable signal 33 during normal use. In this state, the display apparatus of the present embodiment operates similarly with a common display apparatus.

On the other hand, when the inspection of the contents of the memory 2 (check of an expected value) is conducted in, e.g., inspection in a plant, an inspector sets a signal for giving a direction for a test mode to the test enable signal 33. Simultaneously, expected value image data presumed from data stored in the memory 2 is input as image data on the input image signal line 31.

The expected value image data can be easily presumed and generated by an inspector knowing an algorithm for imaging expected value data to be stored in the memory 2 and memory data executed in the display data generation section 14 in TCON 1.

In the case in which the algorithm of the display data comparing section 17 associates “match” and “mismatch” of the comparison results with the black and white displays, the inspector can judge that data stored in the memory 2 matches an expected value (normal) when confirming that the whole display screen is a black display. Further, the inspector can judge that the data does not match the expected value (abnormal) in the case other than the case in which the whole is black, i.e., in the case in which the whole screen region is a white display or in the case in which there is a region which is a white display in the screen.

In particular, when the comparison algorithm in the display data comparing section 17 is in the system of conducting comparison in a region unit or a pixel unit, the position of a memory region that does not match an expected value can be additionally confirmed by confirming a site of a white display in the screen.

In the present embodiment, matching and mismatching are associated with two colors of black and white which are separately painted. However, a similar effect is obtained even if the matching and the mismatching are associated with different two levels or colors other than black and white.

Since a series of the operations can be executed in a single display apparatus, the need of a dedicated inspection jig such as a ROM reader is eliminated and the attachment and detachment operation of the inspection jig for a module is also avoided. Therefore, inspection time can be shortened.

Since the inspection of the memory 2 is conducted while observing a display image as mentioned above, the inspection can be conducted while being incorporated into a part of a display inspection process and, in particular, inspection time can be shortened by making a screen for acceptance or rejection of memory inspection double as another inspection screen. For example, by making the comparison algorithm in the display data comparing section 17 give a black display on the whole in a case in which the result of the inspection of the memory 2 is acceptance (matches an expected value), there is provided such an inspection time shortening effect that a point defect inspection is subsequently conducted without switching the screen if the inspection of the memory 2 is normal. The output image data from the display data comparing section 17 may also be image data matching arbitrary display inspection image data.

In addition, as in the case of other embodiments, there is also the effect of enabling the inspection in the actual operation state in which memory data is actually read in TCON 1 and is operated for the display apparatus.

### Embodiment 4

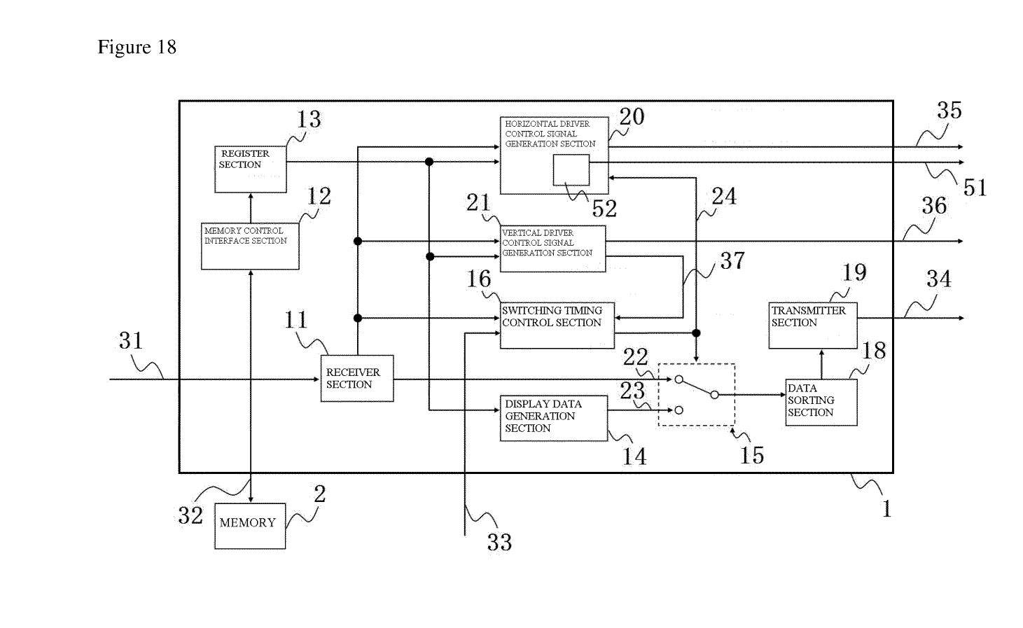

FIG. 18 illustrates a functional block diagram of the inside of TCON 1 carried by a display apparatus in Embodiment 4 of the present invention. The functional block diagram of the display apparatus in Embodiment 4 is the same as the functional block diagram of the display apparatus in Embodiment 1.

The differences between Embodiment 1 and Embodiment 4 are: the change of the operation algorithm of the display data generation section 14 in TCON 1; the addition of a signal line 37 for leading a vertical driver start pulse from the vertical driver control signal generation section 21 to the switching timing control section 16; the change of the switching control algorithm in the switching timing control section 16 to the same algorithm as that of Embodiment 2; and the change of the operation algorithm of a DLP generation section 52 which generates a data latch pulse signal (DLP signal) which is one of horizontal driver control signals generated in the horizontal driver control signal section 20.

The DLP signal 51 generated in the DLP signal generation section 52 is a control signal for deciding timing at which a horizontal driver takes the horizontal driver pixel data 34. The DLP signal 51 is a control signal commonly used in the control of the horizontal driver. The DLP signal 51 is not specified in Embodiments 1, 2, and 3, but is encompassed as one of control signals that configure the horizontal driver control signal 35.

Next, the operation of Embodiment 4 is explained. Most of common horizontal drivers have a charge collection function. A DLP signal is used for deciding the timing of the operation of the charge collection function. The horizontal drivers having the charge collection function electrically establish a short-circuit in a horizontal driver output terminal connected to a driven drain signal line and a horizontal driver output terminal adjacent thereto or all the output terminals of the horizontal drivers in the horizontal drivers in a period in which the DLP signal is at High.

This operation provides the effect of neutralizing the charge of the drain signal line before outputting each line display data and making a potential approach a midpoint potential in the panel to reduce the load of subsequently driving the drain signal line by the horizontal drivers to reduce power consumption.

The great difference between the operations of the present embodiment and Embodiment 1 is in that a memory data visualized image is displayed utilizing the above-mentioned charge collection function. Specifically, when the liquid crystal panel used in the display apparatus is a normally white type liquid crystal panel, TCON 1 outputs black solid image data as horizontal driver pixel data, a black display section performs display based on the data, and a white display section performs display as a white color by the charge collection function controlled by the DLP signal. On the other hand, when the liquid crystal panel used in the display apparatus is a normally black type liquid crystal panel, TCON 1 outputs white solid image data as horizontal driver pixel data, the white display section performs display based on the data, and the black display section performs display as a black color by the charge collection function by the DLP signal.

The detailed operation of Embodiment 4 is explained below. The display data generation section 14 in Embodiment 4 refers to liquid crystal panel information developed on the register section 13 and generates black solid image data or white solid image data. Specifically, the black solid image data and the white solid image data are generated if the liquid crystal panel used in the display apparatus is judged to be the normally white type liquid crystal panel and the normally black type liquid crystal panel, based on the liquid crystal panel information, respectively.

The operation of the switching timing control section 16 in Embodiment 4 is the same as that of Embodiment 2. Specifically, the state of the test enable signal 33 is monitored and, when a signal for giving a direction for a normal operation mode is input, a control signal is output to the internal signal line 24 so that the switch 15 selects the internal signal 22. On the other hand, when a signal for giving a direction for a test mode is input, a control signal is output to the internal signal line 24 so that the switch 15 alternately selects the internal signal 22 and the internal signal 23 in synchronization with the vertical driver start pulse signal 37.

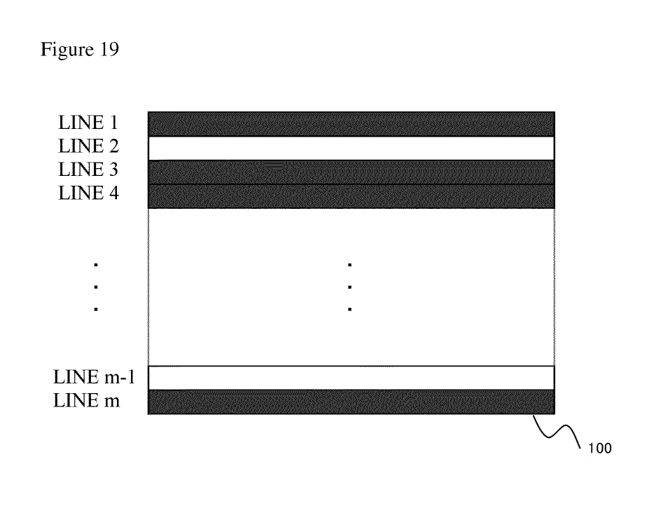

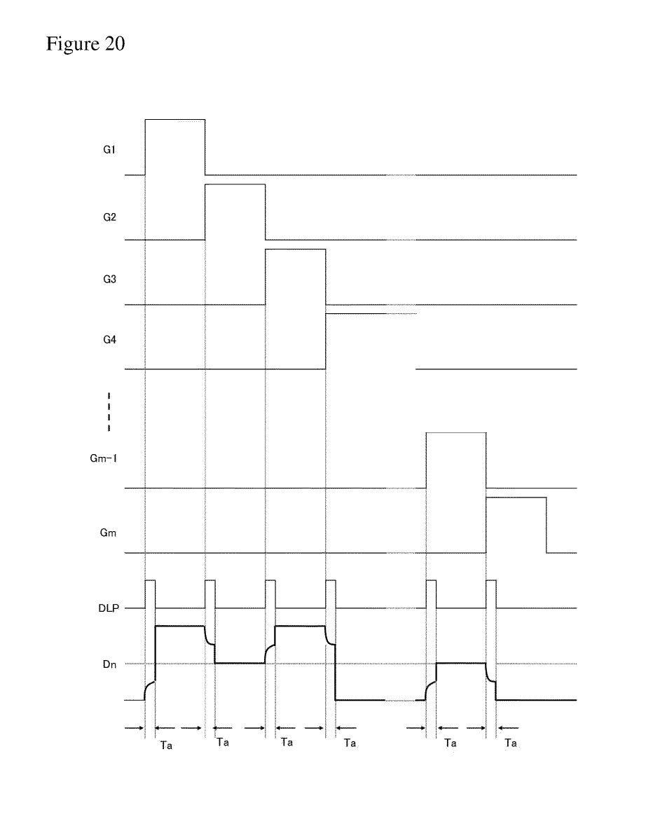

The operation of the DLP signal generation section 52 in Embodiment 4 is changed by the state of the switching signal line 24 for controlling the switch 15. As an example, a time chart of gate signal lines G1 to Gm, a drain signal line Dn, and DLP signals generated in the DLP signal generation section 52 in a case in which image data illustrated in FIG. 19 is input from the input image signal line 31 and is displayed on the normally white type liquid crystal panel in the state in which the switching signal line 24 selects the internal signal line 22 in the switch 15 is illustrated in FIG. 20.

Each gate signal line illustrated in FIG. 20 is connected to each output of the vertical drivers, while each drain signal line is connected to each output of the horizontal drivers. In the state in which the switching signal line 24 selects the internal signal line 22 in the switch 15, the operation of the DLP signal generation section 52 is the same as the DLP signal generation operation of a common liquid crystal display apparatus and High time of the DLP signal is fixed at Ta.

The horizontal drivers takes the horizontal driver pixel data 34 in the positive going edge of the DLP signal and control an output terminal voltage to drive the drain signal line Dn at a voltage corresponding to the taken pixel data.

Since the charge collection function of the horizontal drivers acts in a period of time Ta in which the DLP signal is at High, the potential of the drain signal line Dn approaches a midpoint potential in the panel.

On the other hand, in the state in which the switching signal line 24 selects the internal signal line 23 in the switch 15, the operation of the DLP signal generation section 52 is different from the DLP signal generation operation of a common liquid crystal display apparatus. Specifically, the data of the memory 2 stored in the register section 13 is read and the High time of the DLP signal corresponding to m lines on the screen is dynamically controlled depending on the data value of the read data at m bits.

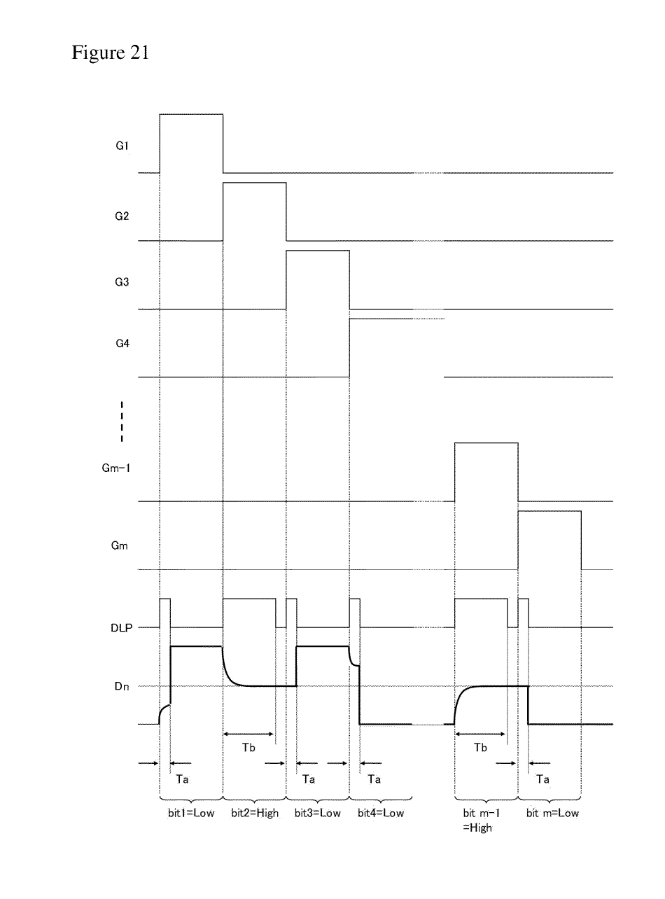

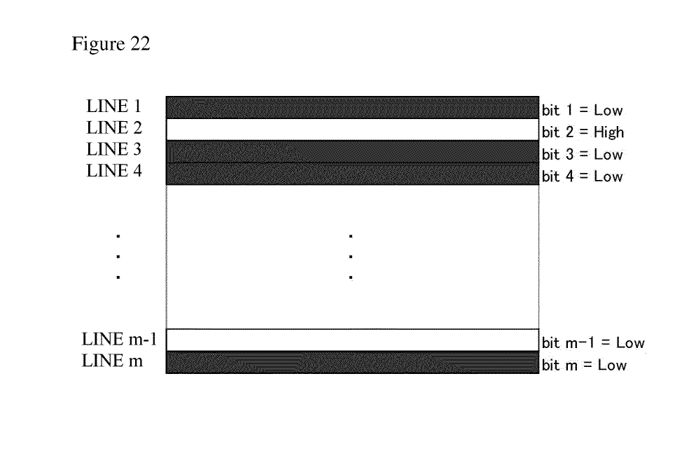

As an example, a time chart of gate signal lines G1 to Gm, a drain signal line Dn, and DLP signals generated in the DLP signal generation section 52 in a case in which m-bit data is displayed on the normally white type liquid crystal panel is illustrated in FIG. 21. Further, an image displayed on the normally white type liquid crystal panel when driving illustrated in FIG. 21 is carried out is illustrated in FIG. 22.

According to FIG. 21, the High time of DLP signals at 2 and m−1 lines corresponding to bit 2 and bit m−1 at which bit values are at High is changed from Ta to Tb. The High time of the DLP signal of a line corresponding to another bit at which a bit value is at Low is Ta, a relationship between Ta and Tb is Ta<Tb, and Tb is shorter than the time of a gate signal On.

The time of the charge collection operation performed by the horizontal drivers in a line at which the High time of the DLP signal is extended to Tb is longer than in a line at which the High time of the DLP signal is Ta. The potential of the drain signal line Dn in this period finally becomes a midpoint potential in the liquid crystal panel.

When the liquid crystal panel used in the display apparatus is a normally white type liquid crystal panel, black solid image data is generated in the display data generation section 14 as mentioned above. However, displays at 2 lines and m−1 lines at which the High time of the DLP signal is extended to Tb and the potential of the drain signal line Dn is a midpoint potential, i.e., the displays of lines corresponding to 2 bits and m−1 bits at which bit values are at High become white as illustrated in FIG. 22. On the other hand, the displays of the lines corresponding to the other bits at which bit values are at Low become black.

On the other hand, when the liquid crystal panel used in the display apparatus is a normally black type liquid crystal panel, a similar display is enabled by changing the association of High/Low of a bit value with the High time Ta/Tb of the DLP signal generated in the DLP signal generation section 52 and by changing image data generated in the data generation section 14. Specifically, a similar display is enabled by setting the DLP signal generation time of a line corresponding to a bit at Low to Tb and the DLP signal generation time of a line corresponding to a bit at High to Ta and making image data generated in the data generation section 14 as mentioned above to be white solid image data.

In addition, the two values High/Low of the bit values are associated with the two colors of white/black in the above example but may also be associated with different two levels or colors other than white/black by arbitrarily controlling the time Tb.

The specific effect of Embodiment 4 is explained. The display apparatus described in the present embodiment sets a signal for giving a direction for a normal operation mode to the test enable signal 33 during normal use. In this state, the display apparatus of the present embodiment operates similarly with a common display apparatus.

On the other hand, when the inspection of the contents of the memory 2 (check of an expected value) is conducted in, e.g., inspection in a plant, an inspector sets a signal for giving a direction for a test mode to the test enable signal 33. Simultaneously, expected value image data presumed from data stored in the memory 2 is input as image data on the input image signal line 31.

The expected value image data can be easily presumed and generated by an inspector knowing an algorithm for imaging expected value data to be stored in the memory 2 and memory data executed in the display data generation section 14 in TCON 1.

The inspector alternately observes an expected value image (image data on the input image signal line 31) and a memory data visualized image in an n-frame display cycle (n is an integer of 1 or more). In this case, when there is no difference between the expected value image and the memory data visualized image, i.e., the data stored in the memory 2 matches the expected value (normal), images displayed in all frames are the same and no flicker is recognized by the inspector.

In contrast, when there is a difference between the expected value image and the memory data visualized image, i.e., the data stored in the memory 2 mismatches the expected value (abnormal), a portion in which the difference is produced is recognized as a flicker by the inspector.

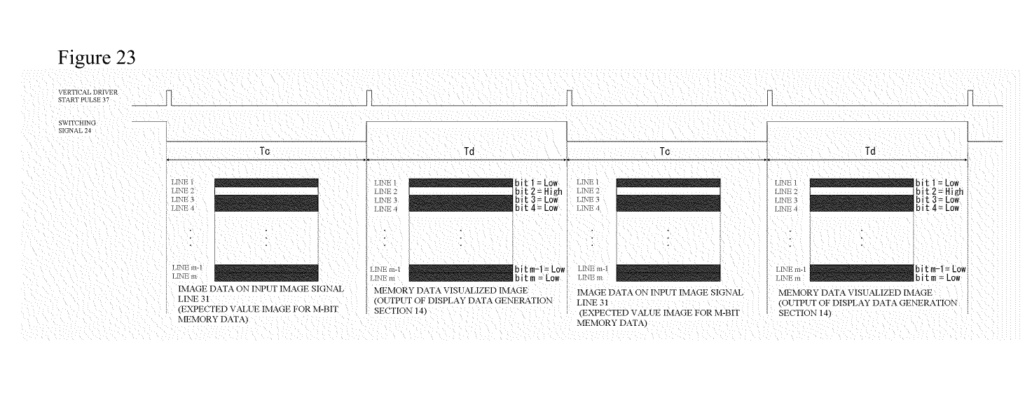

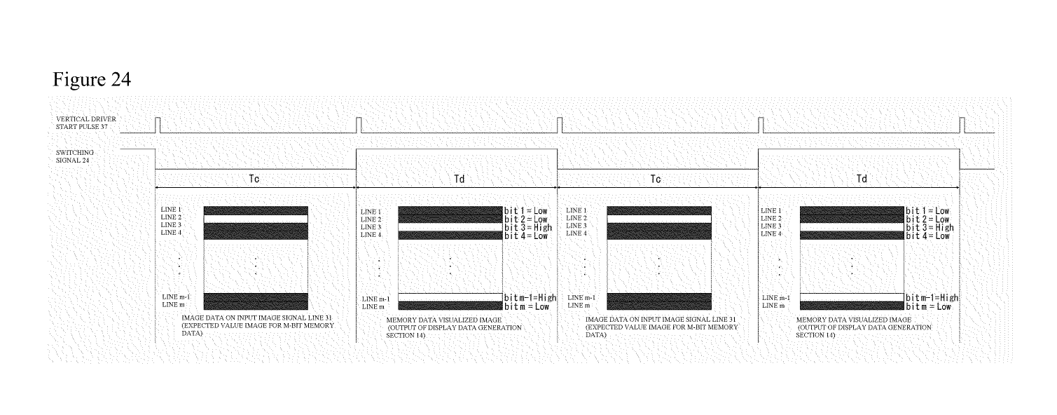

FIG. 23 illustrates a display example in a case in which read memory data matches an expected value, while FIG. 24 illustrates a display example in a case in which read memory data does not match an expected value.

In FIG. 23, there is no difference between an expected value image generated from the memory data expected value and input into the display apparatus and a memory data visualized image generated by actually reading the memory by TCON 1 and no flicker is therefore recognized by the inspector.

On the other hand, in FIG. 24, there is a difference between an expected value image and a memory data visualized image in a display at m−1 bits, i.e., there is a state in which the expected value at m−1 bits does not match the data at m−1 bits read from the memory 2, so that this display region is recognized as a flicker by the inspector.

The inspector can judge whether data stored in the memory 2 is normal or abnormal by confirming the presence or absence of a flicker produced on a screen. A data spot where abnormality occurs can also be known by specifying a spot where the flicker is produced.

Furthermore, as in the case of Embodiment 1, arbitrary display inspection can also be conducted simultaneously with the inspection of the content of memory data by inputting, as image data on the input image signal line 31, image data obtained by synthesizing the expected value image data of memory data and arbitrary image data for display inspection.

In accordance with the present embodiment, a memory data visualized image is exemplified as an image represented by two colors of white/black. However, a similar effect is obtained even in the case of image data represented by different two levels or colors other than white/black.

Since a series of the operations can be executed in a single display apparatus, the need of a dedicated inspection jig such as a ROM reader is eliminated and the attachment and detachment operation of the inspection jig for a module is also avoided. Therefore, inspection operation time can be shortened.

Since the inspection of the memory 2 is conducted while observing a display image as mentioned above, the inspection can be conducted while being incorporated into a part of a display inspection process and, in addition, the inspection of the memory 2 and arbitrary display inspection can also be simultaneously conducted on the same screen, so that inspection time can be shortened.

In addition, as in the case of the other embodiments, there is also the effect of enabling the inspection in the actual operation state in which memory data is actually read in TCON 1 and is operated for the display apparatus.

Further, in the present embodiment, the inspection can be conducted with less power consumption by partially displaying the memory data utilizing the charge collection function of the horizontal drivers.

### Embodiment 5

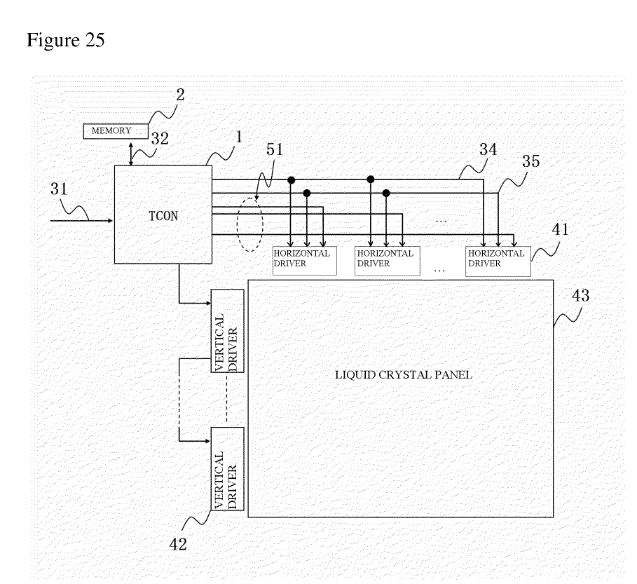

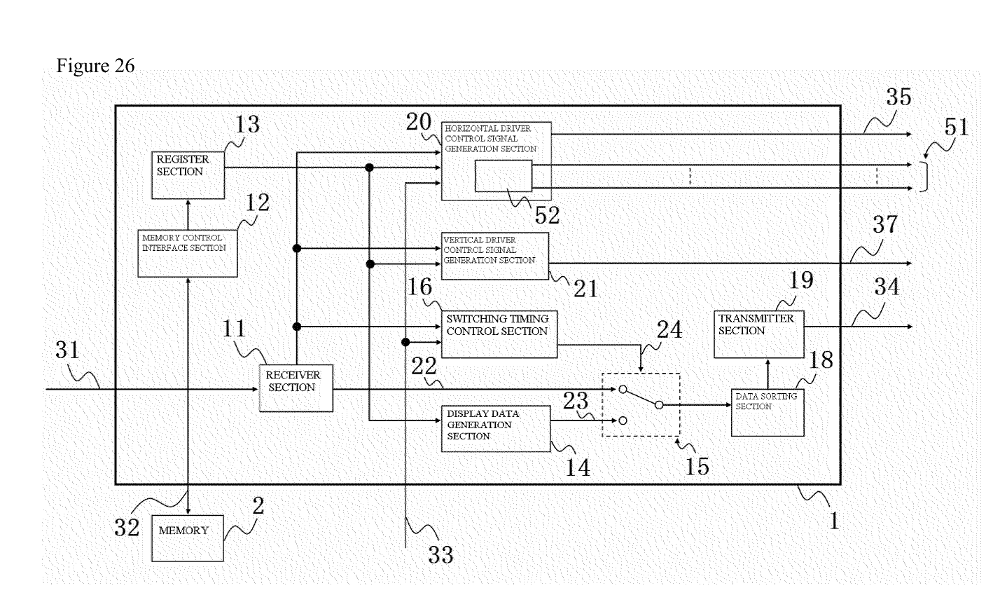

FIG. 25 is a functional block diagram of a display apparatus in Embodiment 5 of the present invention, while FIG. 26 is a functional block diagram in TCON used in the display apparatus of Embodiment 5.

The differences between Embodiment 1 and Embodiment 5 are in that the DLP signal 51 is wired individually to the horizontal drivers in the functional block diagram illustrated in FIG. 25, in that the switching control algorithm in the switching timing control section 16 is different in the TCON functional block diagram illustrated in FIG. 26, in that the operation algorithm of the display data generation section 14 is different, in that the test enable signal 33 is connected to the horizontal driver control signal generation section 20, and in that the operation algorithm of the DLP signal generation section 52 for generating a DLP signal in the horizontal driver control signal generation section 20 is different.

In particular, the difference of the operation of Embodiment 5 from that of Embodiment 1 is explained. The operation of display data generation section 14 is the same as the operation of the display data generation section 14 of Embodiment 4. The difference of the operation of the switching timing control section 16 from the operation of the switching timing control section 16 of Embodiment 1 is in that the unit of splitting the screen is limited to a horizontal driver unit.

The difference of the DLP signal generation section 52 from the DLP signal generation section 52 of Embodiment 4 is in that there are the plural outputs of the DLP signals 51. Furthermore, there is a difference in that the generation algorithms of the DLP signals can be changed individually for the plural DLP signals 51.

A DLP signal generation algorithm in a common liquid crystal display apparatus, more specifically, an algorithm which fixes the High time of the DLP signals at Ta is applied as the DLP signal generation algorithm to all the DLP signals 51 in the period in which the test enable signal 33 is set to a signal for giving a direction for a normal operation mode. This operation is the same as the operation of the DLP signal generation section 52 described in Embodiment 4.

On the other hand, a DLP signal generation algorithm in a common liquid crystal display apparatus or an algorithm which dynamically changes the DLP generation period described in Embodiment 4, more specifically, an algorithm corresponding to data stored in the register section 13 and setting the High time of the DLP signals at Ta or Tb (Ta<Tb) in each display line can be arbitrarily applied in each DLP signal output in the period in which the test enable signal 33 is set to a signal for giving a direction for a test mode. This operation is different from the operation of the DLP signal generation section 52 described in Embodiment 4.

The specific effect of Embodiment 5 is explained. The display apparatus described in the present embodiment sets a signal for giving a direction for a normal operation mode to the test enable signal 33 during normal use. In this state, the display apparatus of the present embodiment operates similarly with a common display apparatus.

On the other hand, when the inspection of the contents of the memory 2 (check of an expected value) is conducted in, e.g., inspection in a plant, an inspector sets a signal for giving a direction for a test mode to the test enable signal 33. Simultaneously, expected value image data presumed from data stored in the memory 2 is input as image data on the input image signal line 31.

The expected value image can be easily presumed and generated by an inspector knowing an algorithm for imaging expected value data to be stored in the memory 2 and memory data executed in the display data generation section 14 in TCON 1.

The inspector compares an expected value image displayed in one screen (=image data on input image signal line 31) with an image generated based on data read from the memory 2 by TCON 1 (memory data visualized image) and judges whether memory data is normal or abnormal based on the presence or absence of a difference between both images.

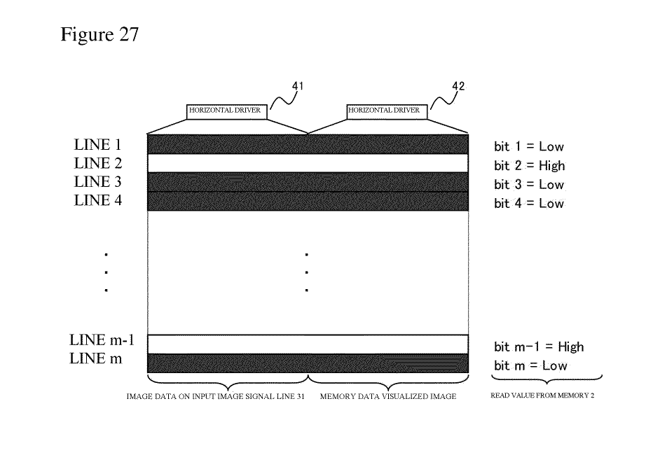

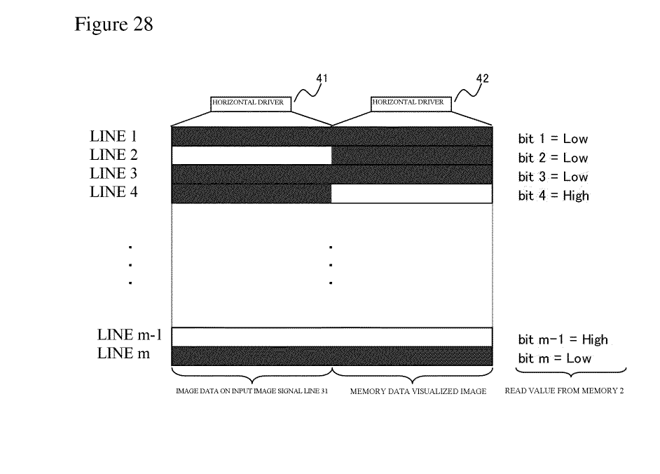

FIG. 27 illustrates an inspection screen display example in a case in which data stored in the memory 2 in the display apparatus with two horizontal drivers is normal (matches an expected value). Further, FIG. 28 illustrates an inspection screen display example in a case in which data stored in the memory 2 in the display apparatus with two horizontal drivers is abnormal (mismatches an expected value).

In the display examples illustrated in FIG. 27 and FIG. 28, the switch 15 in TCON 1 is controlled by the switching timing control section 16 in TCON 1 to output expected value image data on the input image signal line 31 to the screen region corresponding to the horizontal driver in the left side of the screen and solid image data generated in the display data generation section 14 to the screen region corresponding to the horizontal driver in the right side of the screen. The solid image data generated in the display data generation section 14 becomes black solid image data on the whole when the liquid crystal panel used in the display apparatus is a normally white type liquid crystal panel and white solid image data on the whole when the liquid crystal panel used in the display apparatus is a normally black type liquid crystal panel, as in the case of the display data generation section 14 described in Embodiment 4.

Further, algorithms for generating DLP signals are varied between the DLP signal connected to the horizontal driver arranged in the left side of the screen and the DLP signal connected to the horizontal driver arranged in the right side of the screen by the function of the DLP signal generation section 52 in TCON 1.

Specifically, since the algorithm for controlling the DLP signal connected to the horizontal driver located in the left side of the screen has the same operation as a DLP signal generation operation in a common liquid crystal display apparatus, expected value image data on the input image signal line 31 is just displayed on the left side region of the screen. On the other hand, the algorithm for generating the DLP signal connected to the horizontal driver located in the right side of the screen performs control to dynamically change the High period of the DLP signal depending on the read value of the memory 2 stored in the register section 13. Therefore, a memory data visualized image generated by the data read from the memory 2 is displayed on the right region of the screen.

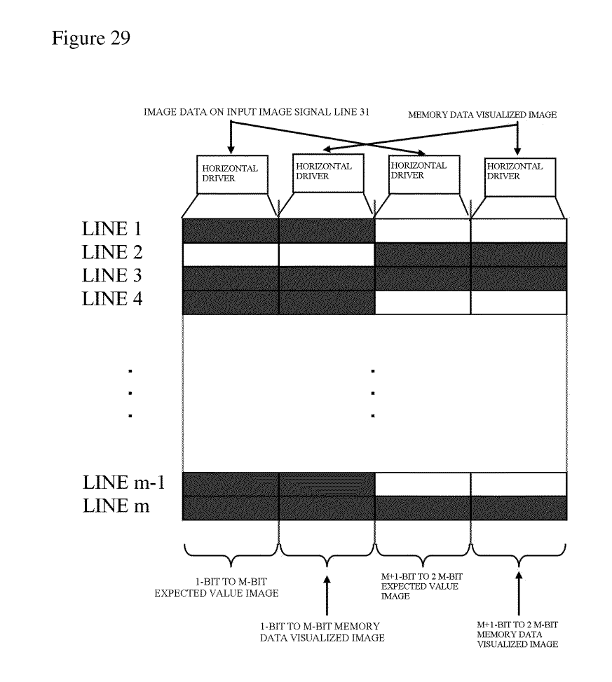

Although memory check equivalent only to m bits based on the number m of longitudinal lines on the screen can be conducted in the above examples, data check of up to n×m bits per screen is possible when the number of splits on the screen is 2n (n is an integer of 1 or more and 2n≦the number of horizontal drivers) in the display apparatus including two or more horizontal drivers. As an example, an inspection screen display example in a case in which the number of splits on a screen is four and 2m-bit data check is conducted in the display apparatus including four horizontal drivers is illustrated in FIG. 29. The number of splits on the screen and a display content in each horizontal driver can be optionally changed by changing the control algorithm of the switching timing control section 16 in TCON 1 and by changing the DLP signal generation algorithm in each DLP signal line set in the DLP signal generation section 52 in TCON 1.

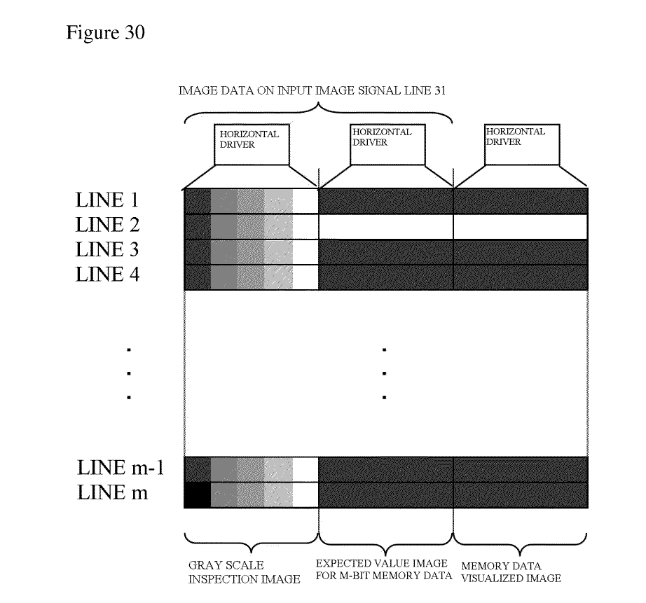

Furthermore, in the display apparatus with three or more horizontal drivers, arbitrary display inspection can also be conducted simultaneously with the inspection of the content of memory data by inputting, as image data on the input image signal line 31, image data obtained by synthesizing the expected value image data of memory data and arbitrary image data for display inspection. As an example, an inspection screen display example in which the expected value image of memory data and a gray scale display inspection image are simultaneously input to simultaneously conduct the inspection of the content of the memory data and gray scale display inspection in the display apparatus with the three or more horizontal drivers is illustrated in FIG. 30.

In accordance with the present embodiment, a memory data visualized image is exemplified as image data represented by two colors of white/black. However, a similar effect is obtained even in the case of image data represented by different two levels or colors other than white/black.

Since a series of the operations can be executed in a single display apparatus, the need of a dedicated inspection jig such as a ROM reader is eliminated and the attachment and detachment operation of the inspection jig for a module is also avoided. Therefore, inspection time can be shortened.

Since the inspection of the memory data 2 is conducted while observing a display image as mentioned above, the inspection can be conducted while being incorporated into a part of a display inspection process and, in addition, the inspection of the memory data 2 and arbitrary display inspection can also be simultaneously conducted on the same screen, so that inspection time can be shortened.

In addition, as in the case of the other embodiments, there is also the effect of enabling the inspection in the actual operation state in which memory data is actually read in TCON 1 and is operated for the display apparatus.

Further, in the present embodiment, the inspection can also be conducted with less power consumption by partially displaying the memory data utilizing the charge collection function of the horizontal drivers, as in the case of Embodiment 4.

### REFERENCE SIGNS LIST

1 TCON
2 Memory
11 Receiver section
12 Memory control interface section
13 Register section
14 Display data generation section
15 Switch
16 Switching timing control section
17 Display data comparing section
18 Data sorting section
19 Transmitter section
20 Horizontal driver control signal generation section
21 Vertical driver control signal generation section
22 Internal signal line
23 Internal signal line
24 Switching signal line
31 Input image signal line
32 Memory control signal line
33 Test enable signal
34 Horizontal driver pixel data
35 Horizontal driver control signal
36 Vertical driver control signal
37 Vertical driver start pulse
41 Horizontal driver
42 Vertical driver
43 Liquid crystal panel
51 DLP signal
52 DLP signal generation section

What is claimed is:

1. A display apparatus comprising a drive circuit for holding and utilizing operation setting data in a memory,
wherein the drive circuit comprises:
a display data generation section which associates two values of data bits read from the memory with two values of light and shade or different colors and makes image data represented in a line or a rectangle;
a switch for selecting the data generated by the display data generation section and input image data; and
a switching timing control section which controls timing of switching.

2. The display apparatus according to claim 1, wherein the switching timing control section controls switching timing to acquire display data in which the image data from the display data generation section and the input image data are arranged in one screen at an arbitrary display ratio.

3. The display apparatus according to claim 1, wherein the switching timing control section controls the switching timing to switch the image data from the display data generation section and the input image data in an arbitrary frame cycle.

4. A display apparatus comprising a drive circuit for holding and utilizing operation setting data in a memory,
wherein the drive circuit comprises:
a display data generation section which associates two values of data bits read from the memory with two values of light and shade or different colors and makes image data represented in a line or a rectangle;
a display data comparing section which compares the data generated by the display data generation section with input image data to output image data indicating the result thereof; and
a switch for selecting the data generated by the display data comparing section and the input image data.

5. The display apparatus according to claim 4, wherein the output image data from the display data comparing section is monochrome solid image data that is uniquely associated with a match or mismatch between comparison results.

6. The display apparatus according to claim 4, wherein the output image data from the display data comparing section is monochrome image data that is uniquely associated with a match or mismatch between comparison results and is separately painted into a match site and a mismatch site.

7. The display apparatus according to claim 4, wherein the output image data from the display data comparing section matches arbitrary display inspection image data.

8. A method for inspecting a display apparatus comprising:
arranging and displaying input display data and data obtained by imaging operation setting data; and
inspecting matching thereof.

9. A method for inspecting a display apparatus comprising:
alternately displaying input display data and data obtained by imaging operation setting data in an arbitrary frame cycle; and
inspecting the presence or absence of a flicker.

10. A method for inspecting a display apparatus comprising:
displaying a comparison result screen for input display data and data obtained by imaging operation setting data; and
confirming whether the screen is an acceptance screen or not.

11. A method for inspecting a display apparatus comprising using a comparison result screen display for input display data and data obtained by imaging operation setting data, doubling as another display inspection screen.
